(19) United States
(12) Patent Application Publication
(10) Pub. No.: US 2024/0384095 A1
(43) Pub. Date: Nov. 21, 2024

(54) Powder based on polyaryletherketone(s) for the manufacture of ductile objects

(71) Applicant: ARKEMA FRANCE, COLOMBES (FR)

(72) Inventors: Benoît BRULE, Serquigny (FR); Nadine DECRAEMER, Serquigny (FR)

(73) Assignee: ARKEMA FRANCE, COLOMBES (FR)

(21) Appl. No.: 18/696,337

(22) PCT Filed: Sep. 26, 2022
(86) PCT No.: PCT/FR2022/051805

§ 371 Date: Mar. 27, 2024

(30) Foreign Application Priority Data
Sep. 28, 2021 (FR) FR2110215

(51) Int. Cl. C08L 71/00; C08J 3/12

(52) U.S. Cl. CPC C08L 71/00; C08J 3/12; C08J 2371/10

(57) ABSTRACT

The invention relates to a powder comprising particles consisting of a composition comprising at least one polyaryletherketone and at least one flexible thermoplastic polymer. The elastic modulus of the flexible thermoplastic polymer is at least two times lower than that of the polyaryletherketone. The polyaryletherketone forms a matrix in which the flexible thermoplastic polymer is dispersed. The powder particles have a volume-weighted particle size distribution with a median diameter d50 of strictly less than 500 μm. The invention also relates to a process for manufacturing the powder and to uses thereof and objects derived therefrom.

### TECHNICAL FIELD

The invention relates to the field of polyaryletherketones.

More particularly, the invention relates to a powder based on polyaryletherketone(s) for the manufacture of ductile objects, in particular for the manufacture of objects by a process for the layer-by-layer construction of objects by electromagnetic radiation-mediated sintering.

### PRIOR ART

Polyaryletherketones (PAEKs) are well-known high-performance engineering polymers. They may be used for applications which are restrictive in terms of temperature and/or in terms of mechanical constraints, or even chemical constraints. They may also be used for applications requiring excellent fire resistance and little emission of fumes or of toxic gases. Finally, they have good biocompatibility. These polymers are found in fields as varied as the aeronautical and aerospace sector, offshore drilling, motor vehicles, the railroad sector, the marine sector, the wind power sector, sport, construction, electronics or medical implants.

Despite these advantageous properties, it is occasionally necessary to formulate polyaryletherketones in order to satisfy specific specifications. Thus, a greater flexibility may be sought, making it possible to adapt to new methods for using and installing parts, with greater bendability. In particular, polyaryletherketone formulations may be sought that are more ductile, i.e. that exhibit a greater deformation at break and/or exhibit a lower tensile/flexural elastic modulus and/or a higher impact strength, compared to an unformulated PAEK.

For example, compositions consisting of polyetheretherketone (PEEK) and polyoctenylene are known from US 2009/0292073.

Compositions consisting of polyetheretherketone (PEEK) and polysiloxane are also known from US 2005/004326 A1.

Compositions consisting of a mixture of PEEK and polysiloxane/polyetherimide block copolymer are furthermore known from US 2010/0147548 A1. More specifically, non-delaminating mixtures of PEEK and comprising from 10% to 25% by weight of polysiloxane/polyetherimide block copolymer, comprising from 20% to 30% by weight of polysiloxane, have been manufactured (see in particular Table 2 of the patent document).

Compositions consisting of a mixture of PEEK, of polyetherimide and of polysiloxane/polyetherimide block copolymer are also known from EP 0 323 142 A1.

Compositions consisting of a mixture of PEEK and of: i) copolymer composed of repeating units derived from tetrafluoroethylene and propylene or ii) copolymer composed of repeating units derived from hexafluoropropylene and vinylidene are also known from US 2019/0055390 A1.

Lastly, compositions consisting of a mixture of PEKK, a polysiloxane/polyetherimide block copolymer and a polysiloxane are known from EP 3 749 714 A1. Although the patent document makes provision for the use of this composition in powder form, no embodiment has been detailed. It is only indicated that such a powder can be obtained according to a standard milling process. However, as explained below, existing milling processes, which are already complex to implement for pure polyaryletherketone compositions, in fact turn out to be impossible to implement for more ductile compositions.

This is in particular the reason why none of the abovementioned patents uses powder production means. All the mixtures are obtained by compounding, a method which aims to obtain homogeneous granules of the chosen formulation. These granules are then used for shaping the final object by various processes, in particular extrusion or injection molding.

The methods commonly used to manufacture powders based on polyaryletherketone(s) are milling methods which all have the common feature of making the material to be milled brittle enough to be able to be milled.

For example, it is known from U.S. Pat. No. 20,092,80263 A1 to mill coarse particles of polyetheretherketone under cryogenic conditions. Specifically, the decrease in temperature makes the material more brittle. This process proves to be ineffective for granules of ductile composition based on polyaryletherketone(s).

It is also known from EP2776224 to mill coarse particles of polyetherketoneketone at room temperature, starting from particles having a low enough tapped density, and therefore incidentally a high enough porosity. Granules of ductile composition based on polyaryletherketone(s) have a density that is too high to be able to be used in the room-temperature milling process. Furthermore, it is not currently known how to obtain coarse particles of ductile composition based on polyaryletherketone(s) that have a low enough density.

Lastly, it is known from WO21069833 to mill coarse particles of polyetherketoneketone comprising a talc-type filler, thus making the coarse particles more brittle. However, the addition of such a filler has the effect of increasing the elastic modulus of the composition and therefore has an effect contradictory to that sought in the present invention.

Thus, none of the abovementioned milling methods is suitable for providing fine powders, that is to say in particular powders having a volume-weighted particle size distribution with a median diameter of strictly less than 500 μm, from ductile compositions based on polyaryletherketone(s).

However, there is currently a need to provide such powders of ductile composition for processes for manufacturing articles using compositions in pulverulent form. One example of a process, which is particularly detailed below in the present application, is a process for the layer-by-layer construction of objects by electromagnetic radiation-mediated sintering.

Other examples of processes requiring a pulverulent composition are powder coating, for example of metals, powder compression molding or powder compression-transfer molding.

### Objectives

One objective of the invention is to provide a process for obtaining a fine powder of ductile composition based on polyaryletherketone(s), and also the powder as such, the latter never having been able to be used in the prior art.

Another objective of the invention is, at least according to certain embodiments, to provide a powder and a process for its manufacture, the powder being suitable for use in a process for the layer-by-layer construction of objects by electromagnetic radiation-mediated sintering.

Another objective of the invention is, at least according to certain embodiments, to provide a powder and a process for its manufacture, the powder being suitable for use in a coating process using a powder, a powder compression molding process or powder compression-transfer molding process.

Another objective of the invention is, at least according to certain embodiments, to provide a powder having a high density.

Another objective of the invention is, at least according to certain embodiments, to provide a powder having a good pourability.

Another objective of the invention, at least according to certain embodiments, is to provide an at least partially crystalline powder.

Finally, one objective of the invention is to provide an object having better ductility and/or better impact strength, compared to the objects obtained from unformulated polyaryletherketone(s), in particular from polyaryletherketone(s) alone.

### SUMMARY OF THE INVENTION

The invention relates to a powder comprising particles consisting of a composition comprising at least one polyaryletherketone and at least one flexible thermoplastic polymer which is not a polyaryletherketone. The elastic modulus of said at least one flexible thermoplastic polymer is at least two times lower than that of said at least one polyaryletherketone, as measured according to the ISO 527-2:2012 standard, at 23° C., on a 1BA test specimen obtained by injection molding, with a crosshead speed of 1 mm/min. Said polyaryletherketone forming a matrix wherein said flexible thermoplastic polymer is dispersed. Lastly, the particles consisting of the composition described above have a volume-weighted particle size distribution, as measured by laser diffraction, according to the ISO 13320:2009 standard, with a median diameter d50 of strictly less than 500 μm, and preferably less than or equal to 300 μm,

The inventors have unexpectedly succeeded in manufacturing a powder comprising particles of a composition in which at least one flexible thermoplastic polymer is dispersed in a matrix comprising at least one polyaryletherketone, which had never been able to be carried out before by the various milling techniques normally used.

This has been achieved owing to the use of the manufacturing process according to the invention comprising:
a step of supplying, in the melt state, a composition comprising the flexible thermoplastic polymer(s) dispersed in the polymer matrix comprising the polyaryletherketone(s);
a step of spraying said composition in the melt state, to form droplets of molten composition;
a step of cooling the droplets of molten composition to form solid particles; and,
optionally one or more heat treatment steps.

The inventors have observed here, surprisingly, that this melt spraying process could be carried out without particular difficulty with a mixture of polymers in order to obtain particles consisting of a dispersion of one polymer in the other.

According to certain embodiments, the flexible thermoplastic polymer may have an elastic modulus of less than or equal to 1.5 GPa, as measured at 23° C. according to the ISO 527-1:2019 standard, on a 1BA test specimen obtained by injection molding.

According to certain embodiments, the flexible thermoplastic polymer(s) may be selected from the list consisting of: a linear polyene, a polysiloxane, a polysiloxane block copolymer, a fluoroelastomer comprising at least one repeating unit derived from: tetrafluoroethylene, hexafluoropropylene, vinylidene fluoride and chlorotrifluoroethylene, and the mixture of these polymers.

The fluoroelastomer may in particular be a copolymer consisting essentially of, or consisting of: a repeating unit derived from tetrafluoroethylene and a repeating unit derived from the monomer of chemical formula CF₂═C(F)(R),
wherein R represents: a —CF₃ group or an —OR_{f} group, where R_{f} is a C₁-₅ perfluoroalkyl; and,
preferentially, said fluoroelastomer may essentially consist of, or consist of, a repeating unit derived from tetrafluoroethylene and a repeating unit derived from hexafluoropropylene.

The block copolymer containing polysiloxane blocks may in particular be a copolymer wherein the polysiloxane blocks are monosubstituted or disubstituted with preferentially C₁to C₁₂ alkyl groups, and/or phenyl groups optionally substituted with one or more functional groups; and the blocks of units other than polysiloxanes may preferentially be polyetherimide, polyaryletherketone, polyarylethersulfone, poly (phenylene sulfide), polyarylamideimide, polyphenylene, polybenzimidazole and/or polycarbonate blocks.

According to certain embodiments, the flexible thermoplastic polymer(s) may represent in total from 5% to 40%, and preferentially from 7% to 25%, by weight relative to the total weight of flexible thermoplastic polymer(s) and polyaryletherketone(s) of the composition.

According to certain embodiments, the total weight of said polyaryletherketone(s) and flexible thermoplastic polymer(s) may represent at least 85%, or at least 90%, or at least 92.5%, or at least 95%, or at least 97.5%, or at least 98%, or at least 98.5%, or at least 99% or at least 99.5%, or 100%, relative to the total weight of the composition.

In certain embodiments, the composition may consist of: a polyaryletherketone, a flexible thermoplastic polymer, optionally a polymer other than the polyaryletherketone and the flexible thermoplastic polymer, which is miscible with the polyaryletherketone, and optionally one or more functional additives.

In certain embodiments, the powder particles may have a volume-weighted particle size distribution, as measured by laser diffraction, according to the ISO 13320:2009 standard, with a median diameter d50 ranging from 40 to 140 micrometers, preferably ranging from 50 to 120 micrometers, and more preferably ranging from 60 to 110 micrometers.

According to certain embodiments, the powder may have a particularly advantageous tapped density and/or pourability.

It may notably have a tapped density of greater than or equal to 500 kg/m³, as measured according to the ISO 1068:1975 standard.

It may notably have a pourability of less than or equal to 10 seconds, preferentially less than or equal to 7 seconds, and extremely preferably less than or equal to 5 seconds, as measured according to Method “A” of the ISO 6186:1998 standard, the powder furthermore having no pourability agent.

According to certain embodiments, in particular when the process is carried out without an additional heat treatment step, the powder may be in amorphous form.

According to certain other embodiments, in particular when the process is carried out with at least one heat treatment step, the powder may be in crystalline form.

It may in particular have a degree of crystallinity of greater than or equal to 10%, and preferentially greater than or equal to 15%, and more preferably greater than or equal to 15%, by weight relative to the total weight of polymers in the composition, as measured by X-ray diffraction.

According to certain embodiments, said at least one polyaryletherketone is a polyetherketoneketone, preferentially consisting essentially of, and more preferably consisting of: a terephthalic unit and, where appropriate, an isophthalic unit, the terephthalic unit (T) having the chemical formula:

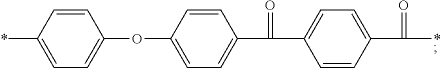

the isophthalic unit (I) having the chemical formula:

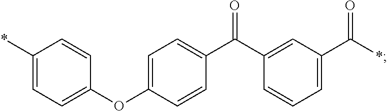

with a T:I molar ratio ranging from 0:100 to 85:15.

The invention also relates to the use of such a powder in a process for the layer-by-layer construction of objects by electromagnetic radiation-mediated sintering, in a powder coating, powder compression molding or powder compression-transfer molding process.

The invention finally relates to an object based on polyaryletherketone(s) which is obtained by one of the abovementioned manufacturing processes, that is to say processes requiring the use of material in pulverulent form. The invention relates in particular to an object obtained by a process for the layer-by-layer construction of objects by electromagnetic radiation-mediated sintering.

The object according to the invention has mechanical properties which were not able to be obtained previously, a person skilled in the art not having been able to use until now a powder comprising at least one flexible thermoplastic polymer dispersed in a matrix of polyaryletherketone(s).

According to certain embodiments, the object may have an elastic modulus of strictly less than 4 GPa, as measured on a 1BA test specimen at 23° C. according to the ISO 527-1:2019standard.

According to certain embodiments, the object may have a Charpy impact strength of greater than or equal to 5 kJ/m², preferentially greater than or equal to 6 kJ/m^{2,} preferentially greater than or equal to 7 kJ/m², preferentially greater than or equal to 8 KJ/m², and extremely preferably greater than or equal to 9 KJ/m², for a type A notched bar according to the ISO 179:2010 standard.

### FIGURES

The invention will be better understood in light of the detailed description that follows of nonlimiting embodiments and the following figures:

FIG. 1 schematically represents a device for performing a process for the layer-by-layer construction of a three-dimensional object by sintering in which the powder according to the invention may be used.

FIG. 2 schematically represents a melt spraying device.

### DETAILED DESCRIPTION OF THE INVENTION

### Definitions

The term “thermoplastic polymer” is understood to denote a polymer which becomes less viscous, or more liquid, or liquid when heated sufficiently and which reversibly retains its thermoplasticity. Thermoplastic polymers are generally contrasted with thermosetting polymers which are irreversibly transformed into an insoluble polymer network that is not heat-formable.

The term “homopolymer” is understood to denote a polymer consisting of a single repeating unit.

The term “copolymer” is understood to denote a polymer resulting from the copolymerization of at least two types of monomers which are chemically different, referred to as comonomers. A copolymer is thus formed of at least two different repeating units derived from different monomers. It can also be formed of three or more repeating units derived from different monomers.

The copolymer may have a homogeneous structure, in particular of statistical, alternating or random type, or a heterogeneous structure, in particular of block type.

In particular, the term “sequential copolymer” or “block copolymer” is understood to denote copolymers in the abovementioned meaning, in which at least two distinct homopolymer blocks are covalently bonded. The length of the blocks can be variable. The blocks may be composed of 1 to 1000, preferably 1 to 100, and in particular 1 to 50 repeating units, respectively. The link between the two homopolymer blocks can be: a simple covalent bond or an intermediate non-repeating unit known as a junction block.

The term “consisting essentially of unit(s)” is understood to mean that the unit(s) represent(s) a molar proportion of 95% to 99.9% relative to the total number of moles of repeating units in the polymer.

The term “consisting of unit(s)” is understood to mean that the unit(s) represent(s) a molar proportion of at least 99.9%, in particular 100%, in the polymer relative to the total number of moles of repeating units in the polymer.

The term “mixture of polymers” is understood to denote a macroscopically homogeneous composition of polymers. The term notably encompasses such compositions composed of mutually immiscible phases dispersed at the micrometric or submicrometric scale.

The term “dispersion” is intended to denote a composition comprising several phases. In the mixture according to the invention, the polyaryletherketone forms the continuous phase, or matrix, and the flexible thermoplastic polymer forms the dispersed phase, generally in the form of nodules. The nodules preferentially have a mean size of less than or equal to 5 micrometers and more preferentially less than or equal to 2 micrometers.

The size of the flexible thermoplastic polymer nodules within the composition, in particular within the matrix based on polyaryletherketone(s), is evaluated by microscopic analysis and digital processing of a cross section of an object that can be manufactured by a powder process, in particular, a process for the layer-by-layer construction of objects by electromagnetic radiation-mediated sintering. A scanning electron microscope (SEM) may be used. The image obtained can be binarized, which makes it possible to determine the mean size and the maximum size of the nodules.

The term “melting temperature” is intended to denote the temperature at which an at least partially crystalline polymer changes to the viscous liquid state, as measured by differential scanning calorimetry (DSC) according to the standard NF EN ISO 11 357-3:2018 during the second heating, using a heating rate of 20° C./min.

The term “glass transition temperature” is intended to denote the temperature at which an at least partially amorphous polymer changes from a rubbery state to a glassy state, or vice versa, as measured by differential scanning calorimetry (DSC) according to the standard NF EN ISO 11 357-2:2020 during the second heating, using a heating rate of 20° C./min.

The melting temperature and glass transition temperature are expressed in degrees Celsius (° C.).

The term “degree of crystallinity” is intended to denote the degree of crystallinity as calculated from wide-angle X-ray scattering (WAXS) measurements, on a Nano-inXider® machine with the following conditions:
Wavelength: main Ka1 line of copper (1.54 angstroms).
Generator power: 50 kV-0.6 mA.
Observation mode: transmission
Counting time: 10 minutes.
Temperature: 25° C.

A spectrum of the scattered intensity as a function of the diffraction angle is thus obtained. This spectrum makes it possible to identify the presence of crystals, when peaks are visible on the spectrum in addition to the amorphous halo. In the spectrum, it is possible to measure the area of the crystalline peaks (denoted A) and the area of the amorphous halo (denoted AH). The (weight) proportion of crystalline phase is estimated by means of the ratio

(A)/(A+AH). The degrees of crystallinity in the present invention are expressed as the weight proportion of crystalline polymer(s) relative to the total weight of polymers in the composition.

The term “amorphous” is understood to mean that the composition has a degree of crystallinity of 7% or less, preferentially of 5% or less, and extremely preferably of 3% or less. According to certain embodiments, the “amorphous” composition may have a degree of crystallinity of around 0%.

The term “crystalline polymer” is understood to mean that the polymer is not amorphous. The polymer then has a degree of crystallinity of strictly greater than 7%.

The term “viscosity” is intended to denote the viscosity as measured at 380° C. and at 1 Hz under an inert atmosphere (N₂), using an Anton Paar MCR 302 oscillatory rheometer, in plate/plate geometry.

The term “tensile modulus of elasticity”, or more simply “elastic modulus”, is understood to mean the slope of the stress-strain curve o (E) in the interval between the two strains ε₁=0.05% and ε₂=0.25%, as defined in the ISO 527-1:2019 standard. The elastic modulus is expressed here in gigapascals (GPa). The slope is preferably measured by a linear regression method.

Although the elastic modulus is determined here by a mechanical tensile stress, it would not be outside the invention if the measurement was taken from other types of stress, for example flexural or compressive stress.

For commercial constituents, the elastic modules are often available on the supplier's product data sheets. In the absence of available or predictable data, tensile elastic modulus measurements can be carried out at 23° C. on a 1BA test specimen with a crosshead speed of 1 mm/min. The actual measurement of the elastic modulus corresponds to the average of five tests performed consecutively. These tests can, for example, be carried out using an MTS 810® machine, sold by MTS Systems Corporation, equipped with a mechanical extensometer.

As regards the characterization of the tensile elastic modulus of the composition of the powder and/or one of its constituents considered in isolation, the 1BA test specimens are manufactured by injection molding according to the ASTM D3641-15 standard. The injection molding conditions are chosen according to one of the following criteria to be considered in the order indicated: conditions imposed by a standard related to the material, instructions given by the supplier, or failing that, the best available information concerning the polymer or a related polymer.

With regard to the characterization of the elastic modulus of an object that can be manufactured by a powder process, the 1BA test specimens are manufactured by said process. For example. 1BA test specimens may be manufactured by a process for the layer-by-layer construction of objects by electromagnetic radiation-mediated sintering.

The term “powder” refers to a fractionated state of matter; which is generally in the form of particles of very small size, generally of about a hundred micrometres or less. The term “pulverulent” refers to a composition which is as a whole in the form of a powder.

The particle size distribution can be measured by laser diffraction according to the standard ISO 13320:2009, for example on a Malvern Mastersizer 2000° diffractometer. The rules for the representation of results of a particle size distribution are given by the standard ISO 9276—parts 1 to 6. The term “d50” is understood to mean the value of the diameter of the powder particles such that the cumulative function of the volume-weighted particle diameter distribution is equal to 50%. Similarly, the terms “d10” and “d90” respectively mean the corresponding diameters such that the cumulative function of the volume-weighted particle diameters is equal to 10% and, respectively, to 90%.

The term “tapped density” is understood to mean the powder density value measured according to the ISO 1068:1975 standard. It can be measured on a STAV 2003 tapping volumeter equipped with a 250 ml cylinder after 2500 pulses. It is expressed in kilograms per cubic meter (kg/m³).

The term “pourability” is intended to denotthise the ability of a powder to flow freely in a uniform and constant manner in the form of individual particles. The pourability is measured here according to method “A” of the standard ISO 6186:1998, with a funnel having an aperture 25 mm in diameter, through which the pulverulent composition can flow. Incidentally, no antistatic agent is added to the composition. The pourability is measured in seconds(s).

The term “Charpy impact strength”, or more simply “impact strength”, is understood to denote the impact strength of type A notched bars with dimensions of 80*10*4 mm³, as measured according to the ISO 179:2010 standard. The actual measurement of the average of 3 tests performed consecutively. A notch (V-shaped with a notch bottom radius of 0.25±0.05 mm) can be made on a device specially provided for this purpose (Automatic Notchvis Plus, sold by CEAST). The bars are then left to rest for 24 h. The impact strength measurement can be performed on a Zwick 5102 impact testing machine.

The singular forms “a(n)” and “the” applied to the constituents of the composition, such as the polyaryletherketone or the flexible thermoplastic polymer, or to a property of these constituents, mean by default “at least one” and respectively “said at least one”. The singular forms nevertheless include, without it being necessary to recall it each time, the embodiments in which “a(n)” means “only one” and “the” means “the sole”.

Throughout the ranges of values set out in the present patent application, the limits are included, unless otherwise mentioned.

### Polyaryletherketone

A polyaryletherketone (PAEK) comprises units of the following formulae:

(—Ar—X—) and (—Ar₁—Y—),

wherein:
Ar and Ar₁ each denote a divalent aromatic radical;
Ar and Ar₁ can preferably be chosen from 1,3-phenylene, 1,4-phenylene, 1,1′-biphenylene divalent in positions 3,3′,1,1′-biphenyl divalent in positions 3,4′,1,4-naphthylene, 1,5-naphthylene and 2,6-naphthylene;
X denotes an electron-withdrawing group; it can preferably be chosen from the carbonyl group and the sulfonyl group;
Y denotes a group chosen from an oxygen atom, a sulfur atom or an alkylene group, such as —(CH)₂— and isopropylidene.

In these X and Y units, at least 50%, preferably at least 70% and more particularly at least 80% of the X groups are a carbonyl group, and at least 50%, preferably at least 70% and more particularly at least 80% of the Y groups represent an oxygen atom.

According to a preferred embodiment, 100% of the X groups denote a carbonyl group and 100% of the Y groups represent an oxygen atom.

Advantageously, the PAEK(s) may be chosen from:
a polyetherketoneketone, also known as PEKK; a PEKK comprises one or more units of formula: —Ph—O—Ph—C(O)—Ph—C(O)—;
a polyetheretherketone, also known as PEEK; a PEEK comprises one or more units of formula: —Ph—O—Ph—O—Ph—C(O)—;
a polyetherketone, also known as PEK; a PEK comprises one or more units of formula: —Ph—O—Ph—C(O)—;
a polyetheretherketoneketone, also known as PEEKK; a PEEKK comprises one or more units of formula: —Ph—O—Ph—O-Ph—C(O)—Ph—C(O)—;
a polyetheretheretherketone, also known as PEEEK; a PEEEK comprises one or more units of formula: —Ph—O—Ph—O—Ph—O—Ph—C(O)—;
a polyetherdiphenyletherketone, also known as PEDEK; a PEDEK comprises one or more units of formula —Ph—O—Ph—Ph—O—Ph—C(O)—;
mixtures thereof; and
copolymers comprising at least two of the abovementioned units,

wherein: Ph represents a phenylene group and —C(O)— represents a carbonyl group, it being possible for each of the phenylenes independently to be of ortho (1,2), meta (1,3) or para (1,4) type, preferentially being of meta or para type.

In addition, defects, end groups and/or monomers can be incorporated in a very small amount in the polymers as described in the above list, without, however, having an effect on their performance.

Preferentially, in the embodiments in which the polyaryletherketone is a copolymer, the latter has a homogeneous structure, in particular of statistical type.

According to certain embodiments, the PAEK is a polyetherketoneketone consisting essentially of, and preferentially consisting of: a terephthalic repeating unit and, where appropriate, an isophthalic repeating unit, the terephthalic repeating unit (“T unit”) having the formula:

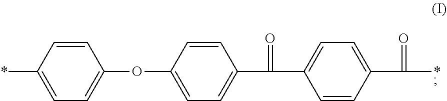

the isophthalic unit (“I unit”) having the formula:

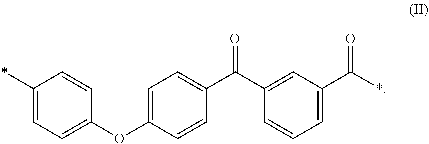

The weight proportion of T units relative to the sum of the T and I units may vary from 0% to 85%. The weight proportion of T units, relative to the sum of the T and I units, may in particular be from 0% to 5%; or from 5% to 10%; or from 10% to 15%; or from 15% to 20%; or from 15% to 20%; or from 20% to 25%; or from 25% to 30%; or from 30% to 35%; or from 35% to 40%; or from 40% to 45%; or from 45% to 50%; or from 50% to 55%; or from 55% to 60%; or from 60% to 65%; or from 65% to 70%; or from 70% to 75%; or from 75% to 80%; or else from 80% to 85%. The choice of the molar proportion of T units, relative to the sum of the T and I units, is one of the factors which makes it possible to adjust the rate of crystallization properties of the polyetherketoneketones. A given molar proportion of T units, relative to the sum of the T and I units, can be obtained by adjusting the respective concentrations of the reactants during the polymerization, in a manner known per se.

For use of the powder in a process for the layer-by-layer construction of objects by electromagnetic radiation-mediated sintering, the weight proportion of T units, relative to the sum of the T and I units, is preferentially from 0% to 25% or from 45% to 75%, and more preferably from 0% to 15% or from 55% to 65%. The weight proportion of T units relative to the sum of the T and I units may notably be around 0% or around 60%.

Such polyaryletherketones are commercially available under the name Kepstan® from Arkema.

According to certain embodiments, the PAEK may be a homopolymer consisting essentially of, or even consisting of, a repeating unit having the formula:

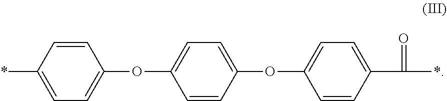

Such polyaryletherketones are commercially available under the name KetaSpire® from Solvay, under the name VestaKeep® from Evonik and PEEK Victrex® from Victrex.

According to certain embodiments, the PAEK may be a copolymer consisting essentially of, or even consisting of, a repeating unit having the formula (III) and a repeating unit having the formula:

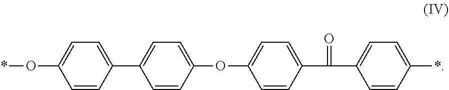

The molar proportion of (III) units relative to the sum of the (III) and (IV) units may range from 0% to 99%, preferentially from 0% to 95%.

According to certain embodiments, the PAEK may be a copolymer consisting essentially of, or even consisting of, a repeating unit having the formula (III) and a repeating unit having the formula:

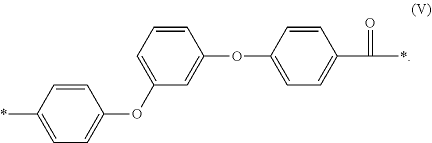

The molar proportion of (III) units relative to the sum of the (III) and (V) units may range from 0% to 99%, and preferentially from 0% to 95%.

The melting temperature of the PAEK is preferably above 280° C., and very particularly above 300° C.

The glass transition temperature of the PAEK is preferably between 100° C. and 250° C., preferably between 120° C. and 200°° C., and very particularly between 140° C. and 180° C.

Advantageously, the PAEK has a viscosity, measured at 380° C. and 1 Hz, of greater than 100Pa·s, preferably greater than 200 Pa·s and more preferably greater than 300 Pa·s. The viscosity of the PAEK is generally not greater than 1500 Pa·s. The viscosity of PAEK may be in particular from 300 Pa·s to 600 Pa·s, or from 600 Pa·s to 800 Pa·s, or from 800 Pa·s to 1000Pa·s, or from 1000 Pa·s to 1200 Pa·s, or from 1200 Pa·s to 1500 Pa·s.

According to certain embodiments, the composition comprises at least two PAEKs. The composition may in particular comprise a copolymer consisting essentially of units consisting essentially of, or consisting of, repeating units of formulae (I) and (II), or (III) and (IV) or alternatively (III) and (V) which represents more than 50%, preferably more than 60%, notably more than 70%, more preferably more than 80% and in particular more than 90% by weight of the polyaryletherketone component, limit included. The remaining 10% to 50% by weight may consist of other polymers belonging to the PAEK family, for example the home a polymer consisting of the repeating unit (III).

According to certain embodiments, the composition comprises a single type of PAEK.

### Thermoplastic Polymer Providing Ductility to the Composition

The thermoplastic polymer providing ductility to the composition, or “flexible thermoplastic polymer”, is not a polyaryletherketone. It has an elastic modulus half that of the polyaryletherketone.

According to preferred embodiments, the elastic modulus of the flexible thermoplastic polymer may be less than or equal to 1.5 GPA. The low value of the elastic modulus has no limit other than that imposed by the very chemical nature of the thermoplastic polymer used. For thermoplastic polymers currently available on the market, the value of the elastic modulus is generally not less than 10 MPa.

According to certain embodiments, the elastic modulus of the flexible thermoplastic polymer may be less than or equal to 1 GPa, or even less than or equal to 750 MPa.

According to certain embodiments, the elastic modulus of the flexible thermoplastic polymer may be greater than or equal to 50 MPa, or even less than or equal to 250 MPa.

According to certain embodiments, the elastic modulus of the flexible thermoplastic polymer may be from 50 MPa to 1000 MPa, or from 250 MPa to 750 MPa.

According to certain embodiments, the flexible thermoplastic polymer may be selected from the list consisting of: a linear polyene, a polysiloxane, a polysiloxane block copolymer, a fluoroelastomer comprising at least one repeating unit derived from tetrafluoroethylene, hexafluoropropylene, vinylidene fluoride and chlorotrifluoroethylene, and the mixture thereof.

According to certain embodiments, said at least one flexible thermoplastic polymer may represent from 5% to 45% by weight relative to the total weight of said flexible thermoplastic polymer(s) and polyaryletherketone(s) of the composition.

Said at least one flexible thermoplastic polymer may in particular represent from 5% to 10%, or from 10% to 15%, or from 15% to 20%, or from 20% to 25%, or from 25% to 30%, or from 30% to 35%, or from 35% to 40%, or from 40% to 45% by weight relative to the total weight of said flexible thermoplastic polymer(s) and polyaryletherketone(s) of the composition.

According to advantageous embodiments, said at least one thermoplastic polymer may represent from 7% to 25% by weight relative to the total weight of said flexible thermoplastic polymer(s) and polyaryletherketone(s) of the composition.

It is known to those skilled in the art that, below a certain proportion of flexible thermoplastic polymer, the contribution of said polymer to the ductility of the composition is low. Moreover, above a certain proportion of flexible thermoplastic polymer, the composition tends to lose the excellent thermal resistance and/or chemical resistance properties conferred by the PAEK. In addition, inter-polymer adhesion problems may appear (delamination) due to insufficient compatibility of the PAEK with the flexible thermoplastic polymer. A person skilled in the art would therefore be led, in a manner known per se, to use a greater or lesser proportion of flexible thermoplastic polymer, taking into account the expected effect and the phenomenon of compatibility.

The viscosity at 380° C. and at 1 Hz of the polyaryletherketone and that of the flexible thermoplastic polymer are close enough so as to facilitate the dispersion of the flexible thermoplastic polymer in the polyaryletherketone matrix.

According to certain embodiments, the maximum viscosity ratio between the polyaryletherketone and the flexible thermoplastic polymer is from 0.3 to 3. Preferentially, this ratio is greater than or equal to 0.5. It may in particular be greater than or equal to 0.7.Preferentially, this ratio is less than or equal to 2. It may in particular be less than or equal to 1.5.

According to certain embodiments, the flexible thermoplastic polymer may be a linear polyene. It is preferentially selected from the list consisting of: poly (3-methyloctenylene), poly (3-methyldecenylene), or a copolymer consisting essentially of, or consisting of, a repeating unit having the chemical formula:

★ [symbol] CH═CH—(CH₂)ₙ [symbol] ★ (VI),

where n is an integer from 3 to 10.

The linear polyene may in particular be chosen from the list consisting of polypentenylene, polyhexenylene, polyheptenylene, polyoctenylene, polynonenylene, polydecenylene, polyundecenylene, polydodecenylene, or a mixture thereof. According to particular embodiments, the linear polyene is a polyoctenylene.

The linear polyene may represent from 5% to 45% by weight relative to the total weight of said flexible thermoplastic polymer(s) and polyaryletherketone(s) of the composition. The linear polyene may in particular represent 25% or less, preferentially 15% or less, by weight relative to the total weight of said flexible thermoplastic polymer(s) and polyaryletherketone(s) of the composition. According to the embodiments in which the linear polyene is the only flexible thermoplastic polymer, it may in particular represent from 5% to 15% by weight relative to the total weight of said flexible thermoplastic polymer(s) and polyaryletherketone(s) of the composition.

According to certain embodiments, the flexible thermoplastic polymer may be a fluoroelastomer comprising at least one repeating unit derived from tetrafluoroethylene (TFE), hexafluoropropylene (HFP), vinylidene fluoride (VDF) and chlorotrifluoroethylene (CTFE).

Preferentially, the fluoroelastomer may be a copolymer consisting essentially of, or consisting of, repeating units derived from HFP and VDF or else a copolymer consisting essentially of, or consisting of, a repeating unit derived from TFE and at least one repeating unit derived from propylene, HFP or else a perfluoro(alkyl vinyl ether).

In particular, the fluoroelastomer may consist essentially of, and preferentially consist of: a repeating unit derived from TFE and a repeating unit derived from the monomer of chemical formula:

CF₂═CF—R (VII),

wherein R represents: a CF₃ group or an OR₁ group, where R₁ is a C₁₋₅ perfluoroalkyl. Preferably, the compound of formula (VII) may be chosen from the group consisting of hexafluoropropylene, perfluoro(methyl vinyl ether), perfluoro(ethyl vinyl ether) and perfluoro(propyl vinyl ether). More preferably, the compound of formula (VII) may be chosen from the group consisting of hexafluoropropylene and perfluoro(propyl vinyl ether). According to certain preferred embodiments, the units derived from TFE may represent from 80 mol % to 99.5 mol % relative to the total number of moles of units derived from TFE and from the monomer of formula (VII). The repeating unit derived from TFE may in particular represent more than 85 mol %, or more than 87 mol %, or more than 93 mol % relative to the total number of moles of units derived from TFE and from the monomer of formula (VII).

According to certain particular embodiments, the flexible thermoplastic polymer is a copolymer consisting essentially of, or consisting of, repeating units derived from TFE and HFP comprising from 7 mol % to 15 mol % of TFE relative to the total number of moles of the units derived from TFE and HFP. Examples of such commercially available fluoropolymers are the polymers of the NEOFLON™ FEP range sold by the company DAIKIN, or of the Teflon® FEP range sold by the company Dupont, or alternatively of the 3M™Dyneon™ Fluoroplastic FEP range sold by the company 3M.

The fluoroelastomer may represent from 10% to 40% and preferentially from 15% to 25% by weight relative to the total weight of said flexible thermoplastic polymer(s) and polyaryletherketone(s) of the composition.

According to certain embodiments, the thermoplastic polymer may be a block copolymer containing polysiloxane blocks.

The polysiloxane blocks may be monosubstituted or disubstituted with C₁ to C₁₂, preferably C₁ to C₆ and very particularly C₁ to C₄ alkyl groups, and/or phenyl groups. Preferably, the alkyl groups are methyl groups. Preferably, the polysiloxane units present in the block copolymer containing polysiloxane blocks are poly(dimethylsiloxane) (PDMS) units.

The alkyl or phenyl groups of the polysiloxane block may also be substituted with one or more functional groups such as epoxy, alkoxy, notably methoxy, amine, ketone, thioether, halogen, nitrile, nitro, sulfone, phosphoryl, imino or thioester. These functional groups may also be located at the end of the chain of the block copolymer containing polysiloxane blocks. Nevertheless, preferably, the polysiloxane block does not include any functional groups. Moreover, the alkyl or phenyl groups of the polysiloxane block may be substituted with one or more carbocyclic, aryl, heteroaryl, alkyl, alkenyl, bicyclic or tricyclic groups.

The block copolymer containing polysiloxane blocks moreover includes blocks of units other than polysiloxanes. They may notably be polyetherimide, poly(aryletherketone), poly(arylethersulfone), poly(phenylene sulfide), poly(arylamideimide), poly(phenylene), poly(benzimidazole) and/or polycarbonate blocks. Preferably, the block copolymer containing polysiloxane blocks also includes polyaryletherketone or polyetherimide blocks. The advantage of these blocks is that they are highly compatible with the polyaryletherketone(s) of the composition and therefore allow the incorporation of a large amount of flexible thermoplastic polymer into the composition.

The polyaryletherketone blocks may be chosen from the same list as that of the polyaryletherketones used as constituent of the composition. According to advantageous embodiments, the polyaryletherketone blocks may have the same chemical composition as that of the polyaryletherketones used as constituent of the composition.

Preferentially, the polyetherimide blocks comprise, consist essentially of, or consist of a repeating unit having the chemical formula:

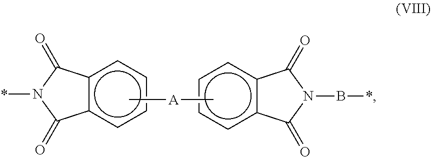

wherein A represents: —O— or a group of formula —O—Z—O—, where the —O— and —O—Z—O— divalent groups are in the 3,3′,3,4′ or 4,4′ position of the benzene radicals to which they are bonded, and
where Z can be chosen from the list consisting of:

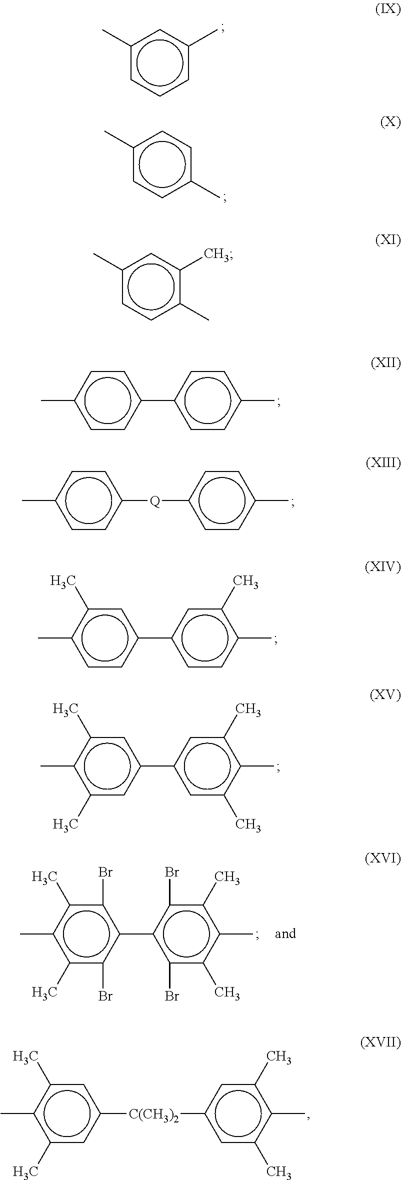

wherein Q is a divalent group selected from the group consisting of: —O—, —S—, —C(O)—, —SO₂—, —SO—, —C_{y}H_{2y}— (y being an integer between 0 and 20) and halogenated derivatives thereof;
wherein B represents an aromatic hydrocarbon group having 6 to 20 carbon atoms or a halogenated derivative thereof, a linear or branched alkylene chain having 2 to 20 carbon atoms, a cycloalkylene
having from 3 to 20 carbon atoms, or a divalent group of formula (XIII).

The block copolymer containing polysiloxane blocks may have a siloxane content of from 10% to 70% by weight, preferentially from 15% to 60% by weight and more preferably from 20% to 50% by weight relative to the weight of the copolymer.

The block copolymer containing polysiloxane blocks may represent from 5% to 20% and preferentially from 7% to 15% by weight relative to the total weight of said at least one thermoplastic and at least one polyaryletherketone of the composition.

Such block copolymers containing polysiloxane blocks are commercially available. Thus, the company Sabic sells copolymers containing PEI-PDMS blocks under the name Siltem®. Moreover, the company Idemitsu Kosan sells a polycarbonate-PDMS copolymer under the name Tarflon® Neo.

According to certain embodiments, the flexible thermoplastic polymer may be a polysiloxane. The polysiloxane may be monosubstituted or disubstituted with C₁ to C₁₂, preferably C₁ to C₆ and very particularly C₁ to C₄ alkyl groups, and/or phenyl groups. Preferably, the alkyl groups are methyl groups. The alkyl or phenyl groups of the polysiloxane may be substituted with one or more functional groups such as epoxy, alkoxy, notably methoxy, amine, ketone, thioether, halogen, nitrile, nitro, sulfone, phosphoryl, imino or thioester.

Nevertheless, preferably, the polysiloxane does not include any functional groups. Moreover, the alkyl or phenyl groups of the polysiloxane may be substituted with one or more carbocyclic, aryl, heteroaryl, alkyl, alkenyl, bicyclic or tricyclic groups.

Preferably, the polysiloxane may be a poly(dimethylsiloxane) (PDMS).

The polysiloxane may represent from 1% to 25% by weight relative to the total weight of said flexible thermoplastic polymer(s) and polyaryletherketone(s) of the composition.

According to certain embodiments, the polysiloxane may represent 2% or more, or 3% or more, or 4% or more, or 5% or more by weight relative to the total weight of said flexible thermoplastic polymer(s) and polyaryletherketone(s) of the composition. Since the polysiloxane has a very low compatibility with polyaryletherketones, it may represent 20% or less, preferentially 15% or less and more preferably 13% or less by weight relative to the total weight of said flexible thermoplastic polymer(s) and polyaryletherketone(s) of the composition.

According to certain embodiments, said at least one flexible thermoplastic polymer of the composition is a mixture of a block copolymer containing polysiloxane blocks, notably a block copolymer further comprising polyaryletherketone or polyetherimide blocks, and a polysiloxane.

### Other Optional Components of the Composition

According to preferred embodiments, the composition may comprise at least 85%, or at least 90%, or at least 92.5%, or at least 95%, or at least 97.5%, or at least 98%, or at least 98.5%, or at least 99% or at least 99.5%, or 100%, by total weight of polyaryletherketone(s) and flexible thermoplastic polymer(s).

The composition preferentially does not comprise a reinforcing filler, and in particular no fibers. In fact, reinforcing fillers generally have the effect of making the material less ductile.

The composition may comprise, in addition to the polyaryletherketone and the flexible thermoplastic polymer, another polymer which is miscible with the polyaryletherketone. This other polymer which is miscible with the polyaryletherketone is therefore incorporated into the matrix in which the flexible thermoplastic polymer is dispersed. In other words, it does not form nodules additional to the nodules of flexible thermoplastic polymer(s).

The composition may also optionally comprise minor amounts, in particular less than 5% by weight relative to the weight of the composition, of functional additives. Examples of such that may be mentioned include antioxidants, stabilizers in the melt state and/or in the solid state, conductive agents and/or antistatic agents, flame retardants, dyes and also reactive agents such as alkaline carbonates.

Thus, according to certain embodiments, the composition may consist of: a polyaryletherketone, a flexible thermoplastic polymer, optionally a polymer other than the polyaryletherketone and the flexible thermoplastic polymer, which is miscible with the polyaryletherketone, and optionally one or more functional additives.

According to particular embodiments, the composition may consist of polyaryletherketone(s) and flexible thermoplastic polymer(s). It may in particular consist of a single polyaryletherketone and a single flexible thermoplastic polymer.

### Powder

The powder according to the invention comprises particles of a composition, several embodiments of which have been described above.

Preferably, the powder does not comprise other particles of a different chemical composition. The powder therefore preferentially consists of a composition as described above comprising at least one polyaryletherketone and at least one flexible thermoplastic polymer. This notably has the advantage, for example in the embodiments in which the powder is used in a process for constructing an object by laser sintering, of being able to carry out an easier recycling of the powder.

In certain embodiments, the particles may have a volume-weighted particle size distribution, as measured by laser diffraction, according to the ISO 13320:2009 standard, with a median diameter d50 ranging from 40 to 140 micrometers. Preferentially, the median diameter d50 may be from 50 to 120 micrometers. More preferably, the median diameter d50 may be from 60 to 110 micrometers.

According to certain embodiments, d10 may be greater than or equal to 15 micrometers, or greater than or equal to 30 micrometers.

According to certain embodiments, d90 may be less than or equal to 300, and preferentially less than or equal to 240 micrometers. The value of d90 may, according to certain embodiments, be less than or equal to 180 micrometers.

According to advantageous embodiments, in particular for application of the powder in a process for the layer-by-layer construction of a three-dimensional object by electromagnetic radiation-mediated sintering, the particle size distribution of the powder may be such that:

d10≥15 μm, 60 μm≤d50≤110 μm, and d90≤240 μm.

According to certain embodiments, in particular for application of the powder in a process for the layer-by-layer construction of a three-dimensional object by electromagnetic radiation-mediated sintering, the particle size distribution of the powder may be such that:

d10≥30 μm, 80 μm≤d50≤100 μm, and d90≤180 μm.

According to certain embodiments, the powder does not comprise any flow agent. Advantageously, even in the absence of a flow agent, it may have a pourability of less than or equal to 10 seconds, preferentially less than or equal to 7 seconds, and extremely preferably less than or equal to 5 seconds.

According to certain embodiments, the powder has a tapped density of greater than or equal to 500 kg/m³. Such powders used in processes for manufacturing objects have a density which approaches the density desired for the objects to be manufactured. This makes it possible to have less air originating from the powder to be evacuated during the process for manufacturing an object, and therefore to more easily obtain objects having a low porosity.

According to certain embodiments, the powder is an amorphous powder.

According to certain embodiments, the powder is crystalline, at least in part. The powder may in particular have a degree of crystallinity of greater than or equal to 10%, and preferentially greater than or equal to 15%, and more preferably greater than or equal to 18%, by weight relative to the total weight of polymers in the composition, as measured by X-ray diffraction.

### Use of the Powders

The powders according to the invention may be used in numerous applications, including the applications listed nonexhaustively below.

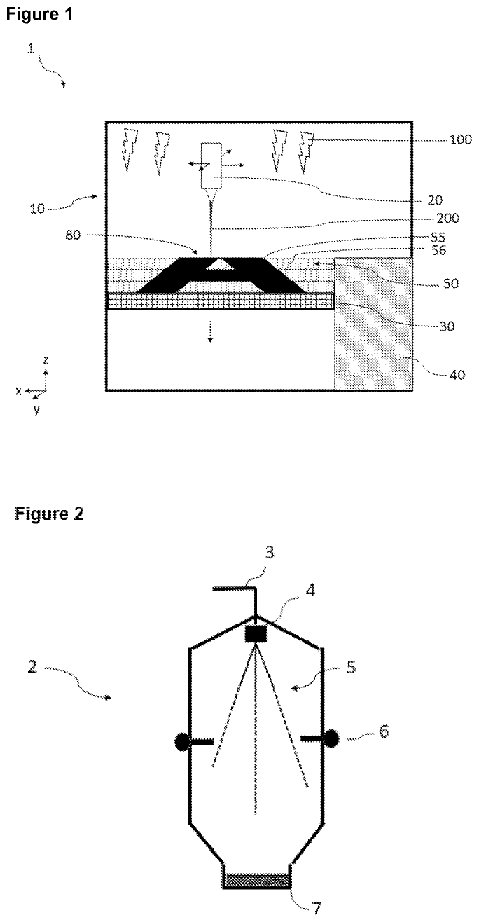

Processes of layer-by-layer construction of objects by sintering mediated by electromagnetic radiation, notably by infrared radiation and laser radiation, are well known to those skilled in the art. With reference to FIG. 1, the laser sintering device 1 comprises a sintering chamber 10 in which are placed a feed tank 40 containing a powder to be sintered, a horizontal plate 30 for supporting the three-dimensional object 80 under construction and a laser 20. Powder is taken from the feed tank 40 and deposited on the horizontal plate 30, forming a thin layer 50 of powder constituting the three-dimensional object 80 under construction. A compacting roller/doctor blade (not shown) ensures good uniformity of the powder layer 50. The powder layer 50, under construction, is heated by means of infrared radiation 100 to reach a substantially uniform temperature equal to a predetermined construction temperature Tc. In conventional construction processes for sintering powders based on PAEK(s), Tc is generally about 20° C. lower than the melting temperature of the powder, as measured by DSC during the first heating with a temperature ramp equal to 20° C./min. In certain cases, Tc may even be lower. The energy required to sinter the powder particles at various points in the powder layer 50 is then provided by laser radiation 200 from the laser 20 that is movable in the plane (xy), in a geometry corresponding to that of the object. The molten powder resolidifies forming a sintered part 55, whereas the rest of the layer 50 remains in the form of unsintered powder 56. Several passes of laser radiation 200 may be necessary in certain cases. Next, the horizontal plate 30 is lowered along the axis (z) by a distance corresponding to the thickness of one layer of powder, and a new layer is deposited. The laser 20 supplies the energy required to sinter the powder particles in a geometry corresponding to this new slice of the object, and so on. The procedure is repeated until the entire object 80 has been manufactured. Once the object 80 has been completed, it is removed from the horizontal plate 30 and the unsintered powder 56 can be screened before being returned, where appropriate, into the feed tank 40 to serve as recycled powder.

The powders according to the invention may also be used in processes for coating surfaces, notably metal surfaces. Various processes may be used in order to obtain a coating on a metal part. Mention may be made of dipping in the fluidized bed for which the metal part is heated and then dipped into the fluidized powder bed. It is also possible to perform electrostatic powder coating (charged powder dusted onto an earthed metal part); in this case, a thermal post-treatment is performed to produce the coating. An alternative is to perform the powder coating on a preheated part, which makes it possible to remove the heat treatment after powder coating. Finally, it is possible to perform flame powder coating; in this case, the powder is melt-sprayed onto an optionally preheated metal part.

The powders according to the invention may also be used in powder compression processes. These processes are generally used for producing thick parts. In these processes, the powder is first loaded into a mold, then compacted and lastly melted to produce the part. Finally, suitable cooling, often fairly slow, is carried out in order to limit the presence of internal stresses in the part.

The objects obtained by these processes have properties which had not been able to be obtained until now owing to the impossibility of manufacturing powders comprising at least one flexible thermoplastic polymer dispersed in a matrix of PAEK(s).

An object obtained by one of the abovementioned processes, preferentially obtained by a process for the layer-by-layer construction of objects by electromagnetic radiation-mediated sintering, may in particular have an elastic modulus of strictly less than 4 GPa, as measured on a 1BA test speciment at 23° C. according to the ISO 527-1:2019 standard.

An object obtained by one of the abovementioned processes, preferentially obtained by a process for the layer-by-layer construction of objects by electromagnetic radiation-mediated sintering, may have a Charpy impact strength of greater than or equal to 5 KJ/m², preferentially greater than or equal to 6 KJ/m², preferentially greater than or equal to 7 kJ/m², preferentially greater than or equal to 8 KJ/m², and extremely preferably greater than or equal to 9 KJ/m², on a type A notched bar according to the ISO 179:2010 standard.

### Process for Manufacturing the Powder

A process for manufacturing a powder according to the invention comprises:
a step of supplying, in the melt state, the composition in the melt state;
a step of spraying the composition in the melt state, to form droplets of molten composition;
a step of cooling the droplets of molten composition to form solid particles; and,
optionally one or more heat treatment steps.

The melt spraying and cooling steps are known per se for a composition that is a pure polymer. They make it possible to obtain a micropowder of said polymer. Such a process has, for example, been described in patent application EP0945173.

With reference to FIG. 2, the melt spraying device 2 comprises means 3 for supplying a composition in the melt state to spray nozzles 4 positioned in the upper part of the device. The spray nozzles 4 spray the composition in the melt state in the form of fine jets which, as they fall, separate into micro-droplets 5. The droplets in the melt state are cooled as they fall so as to solidify. In order to reduce the drop height and/or to accelerate the cooling, a cryogas, for example liquid nitrogen or liquid carbon dioxide, can be blown in gaseous form inside the device by means of feeds 6 positioned on the side walls of the device. A solid micropowder 7 is thus obtained in the lower part of the device.

The mixture in the melt state can be obtained by any process known in the art.

The composition may, for example, be supplied in the form of PAEK granules in which the flexible thermoplastic polymer has been dispersed. Alternatively, each component may be supplied separately and the composition in the melt state may be manufactured in situ by any known melt mixing device suitable for the preparation of thermoplastics. Suitable melt mixing machines are, for example, kneaders, Banbury mixers, single-screw extruders and twin-screw extruders.

The powder obtained by the spraying process is generally amorphous or quasi-amorphous owing to the very rapid cooling of the droplets of molten composition.

The amorphous powder may, where appropriate, undergo one or more heat treatment steps. A (first) heat treatment step may be carried out above the glass transition temperature Tg and below the melting temperature of the polyaryletherketone of the composition so as to give rise to the crystallization of the composition. Optionally, if necessary, a second heat treatment may be carried out so as to make the crystalline phases of the composition uniform. Such a heat-treated powder is particularly suitable for use in a process for the layer-by-layer construction of objects by electromagnetic radiation-mediated sintering.

For example, according to embodiments where the polyaryletherketone(s) of the composition is (are) a PEKK consisting essentially of, or consisting of, isophthalic and terephthalic repeating units, with a T/I molar ratio of from 45:55 to 75:25, in particular a T/I ratio of around 60:40, the heat treatment may be carried out at a temperature of from 160° C. to 300° C., preferentially from 180° C. to 290° C., and more preferably from 190° C. to 250° C. for a sufficient time to obtain the desired crystallinity.

It is also known that PEKK can crystallize in two crystalline forms, referred to as “form I” and “form II”. When this is the case following the first heat treatment, a second heat treatment can advantageously be carried out so as to obtain a powder containing essentially PEKK crystals of form I. This process is known per se and has already been described in application WO 2012/047613. For a powder consisting of a composition comprising a PEKK having a T/I ratio of around 60:40, the temperature of the second heat treatment may in particular be from 230°° C. to 300° C., and preferentially from 260° C. to 295° C. The temperature of the second heat treatment may in particular be from 275° C. to 290° C.

The temperature of the second heat treatment is generally higher than that of the first heat treatment. Thus, continuing with the example of a powder consisting of a composition comprising a PEKK having a T/I molar ratio of around 60:40, a first heat treatment can in particular be carried out at a temperature of from 160° C. to 250° C. and a second heat treatment at a temperature of from 260° C. to 300° C.

### EXAMPLES

### Raw Materials

### The Following Commercial Products Were Used for the Examples

KEPSTAN® of 6000 grade, sold by ARKEMA, is a polyetherketoneketone having a T/I molar ratio of 60/40. This PEKK has a viscosity of 900 Pa·s at 380° C. and 1 Hz. Five 1BA test specimens were prepared by injection molding on a Battenfeld press using the following parameters: feed 330° C.; nozzle: 345° C.; mold 80° C. Under these molding conditions, the test specimens were obtained in essentially amorphous form. The tensile modulus of elasticity was measured at 2.9 GPa according to the ISO 527-1:2019 standard, at 23° C., with a crosshead speed of 1 mm/min.

By way of comparison, the tensile modulus of elasticity of test specimens obtained by laser sintering, having a crystallinity of 20%, was measured at 4 GPa, at 23° C., with a crosshead speed of 1 mm/min (see table 2, composition #3c).
NEOFLON™ NF101, sold by Daikin, is a copolymer essentially consisting of TFE and HFP repeating units (FEP). This FEP copolymer has a viscosity of 1200 Pa·s at 380° C. and 1 Hz. The supplier indicates that its NEOFLON™ FEP range, including NEOFLON™ NF101, has a tensile modulus of elasticity of 440 to 540 MPa (ASTM D 638).
SILTEM® 1500, sold by Sabic, is a polyetherimide-polydimethylsiloxane (PEI/PDMS) block copolymer. SILTEM® 1500 has a weight proportion of 40% of polydimethylsiloxane relative to the total weight of the polymer and has a viscosity of 800 Pa·s at 380° C. and 1 Hz. The supplier indicates that SILTEM® 1500 has a tensile modulus of elasticity of 590 MPa with a crosshead speed of 1 mm/min (ISO 527).

The PEKK was mixed with each of the flexible thermoplastic polymers and extruded using a ZSK Mc¹⁸ twin-screw extruder, sold by Coperion, by introduction into a main hopper and extrusion at a temperature of 320° C. The speed of rotation of the screws was 250 rpm for the PEKK and PEI/PDMS block copolymer mixture and 320 rpm for the PEKK and FEP mixture.

The granules thus obtained were sprayed in a device such as shown in FIG. 2 to obtain a solid powder.

Two successive heat treatments were carried out. The powder was first treated at 185° C. for 6 hours and then at 270° C. for 3 hours.

A control powder #3c was also manufactured in order to compare it with the powders formulated in the examples according to the invention. It consists of PEKK and was manufactured by a conventional process of milling flakes of crystalline polymer, followed by a densification step and a heat treatment step.

PEKK flakes having a viscosity of around 900 Pa·s at 380° C. and 1 Hz were synthesized by an electrophilic process. They were first micronized in an Alpine Hosokawa AFG 200 air jet mill at a temperature of 23° C. in order to obtain a powder having as particle size distribution, d10=30 microns, d50=69 microns and d90=132 microns.

The powder, which is termed “non-densified”, was then subjected to a thermomechanical treatment in a Henschel rapid mixer, with a blade tip speed of about 43 m/s, for 60 minutes. A densified powder was thus able to be obtained. The tapped density of the densified powder is 440 kg/m³. The densified powder was finally heat treated at 275° C. for 4 hours.

The table below shows the characteristics of powders #1 to #3c:

TABLE 1

| | Polymer | Proportion | | | | Tapped | | % crystallinity |
|---|---|---|---|---|---|---|---|---|
| | blended | (% by | d10 | d50 | d90 | density | Pourability | (% by |
| Powder | with PEKK | weight) | (μm) | (μm) | (μm) | (kg/m³) | (s) | weight) |
| #1 | PEI/PDMS | 10% | 43 | 95 | 155 | 0.59 | 4 | 20 |
| #2 | FEP | 20% | 47 | 90 | 144 | 0.54 | 4 | 20 |
| #3c | * | * | 30 | 69 | 132 | 0.46 | 8 | 20 |

1BA test specimens and bars with dimensions of 80*10*4 mm³ or printed in the xy plane using a P810 printer sold by EOS. The build temperature was set at 285° C. and the energy of the laser at 29 mJ/mm².

The 1BA test specimens were used to determine the tensile modulus of elasticity of an object manufactured by laser sintering of powder, at 23° C., with a crosshead speed of 1 mm/min.

The bars, V-notched in advance and then left to rest for 24 hours, were used to determine the Charpy impact strength.

The table below shows the results of these tests:

TABLE 2

| Composition | Elastic modulus (GPa) | Charpy impact (kJ/m²) |
|---|---|---|
| #1 | 3 | 11 |
| #2 | 3.6 | 10 |
| #3c | 4 | 4 |

Thus, powders #1 and #2, according to the invention, made it possible to manufacture objects obtained by laser sintering based on PEKK and having a lower elastic modulus and a higher impact strength compared to what it was possible to manufacture with powders according to the prior art (powder #3c).

### Another Comparative Example: Production of Powder from PEKK Granules Obtained by Compounding

PEKK granules with a size of around 2 mm were extruded. The granules were then heat treated for 9 h at 180° C., in order to increase their crystallinity and make them more brittle for the milling step. Finally, they were milled in a Mikropul 2DH® cryogenic hammer mill cooled with liquid nitrogen, the mill furthermore being equipped with a screen with round holes of 500 microns. The powder obtained has a d50 of 500 microns.

Thus, for PEKK granules obtained by compounding, it is generally impossible to obtain, by milling, a powder having a d50 of strictly less than 500 microns, even under cryogenic conditions and having crystallized said granules beforehand.

The milling, under similar conditions, of granules obtained by compounding compositions consisting of PEKK and a flexible thermoplastic polymer, such as the granules used for the manufacture of powders #1 and #2, would be even more difficult to implement and would not make it possible to obtain powders having a d50 of strictly less than 500 microns.

1. A powder comprising particles consisting of a composition comprising at least one polyaryletherketone and at least one flexible thermoplastic polymer which is not a polyaryletherketone, wherein the particles have a volume-weighted particle size distribution as measured by laser diffraction, according to the ISO 13320:2009 standard, with a median diameter d50 of strictly less than 500 μm,
the elastic modulus of said at least one flexible thermoplastic polymer being at least two times lower than that of said at least one polyaryletherketone, as measured according to the ISO 527-2:2012 standard, at 23° C., on a 1BA test specimen obtained by injection molding, with a crosshead speed of 1 mm/min,
said polyaryletherketone forming a matrix wherein said flexible thermoplastic polymer is dispersed.

2. The powder as claimed in claim 1, wherein said flexible thermoplastic polymer has an elastic modulus of less than or equal to 1.5 GPa, as measured according to the ISO 527-2:2012 standard at 23° C. on a 1BA test specimen.

3. The powder as claimed in claim 1, wherein said at least one flexible thermoplastic polymer is selected from the list consisting of: a linear polyene, a polysiloxane, a polysiloxane block copolymer, a fluoroelastomer comprising at least one repeating unit derived from: tetrafluoroethylene, hexafluoropropylene, vinylidene fluoride and chlorotrifluoroethylene, and the mixtures of these polymers.

4. The powder as claimed in claim 3, wherein said at least one flexible thermoplastic polymer comprises a fluoroelastomer consisting essentially of, or consisting of:
a repeating unit derived from tetrafluoroethylene and a repeating unit derived from the monomer of chemical formula CF₂═C(F)(R),
wherein R represents: a —CF₃ group or an —ORf group, where Rf is a C₁₋₅ perfluoroalkyl.

5. The powder as claimed in claim 3, wherein said at least one flexible thermoplastic polymer comprises a block copolymer containing polysiloxane blocks.

6. The powder as claimed in claim 1, wherein said at least one flexible thermoplastic polymer represents from 5% to 40%, and preferentially from 7% to 25%, by weight relative to the total weight of said at least one flexible thermoplastic polymer and at least one polyaryletherketone of the composition.

7. The powder as claimed in claim 1, wherein the total weight of said polyaryletherketone(s) and flexible thermoplastic polymer(s) represents at least 85%, relative to the total weight of the composition.

8. The powder as claimed in claim 1, wherein the composition consists of: a polyaryletherketone, a flexible thermoplastic polymer, optionally a polymer other than said polyaryletherketone(s) and flexible thermoplastic polymer(s), this other polymer being miscible with said at least one polyaryletherketone, and optionally one or more functional additives.

9. The powder as claimed in claim 1, the particles of which have a volume-weighted particle size distribution, as measured by laser diffraction, according to the ISO 13320:2009 standard, with a median diameter d50 ranging from 40 to 140micrometers.

10. The powder as claimed in claim 1, which has a tapped density of greater than or equal to 500 kg/m³, as measured according to the ISO 1068:1975 standard.

11. The powder as claimed in claim 1, which has no flow agent and which has a pourability of less than or equal to 10 seconds as measured according to Method “A” of the ISO 6186:1998 standard.

12. The powder as claimed in claim 1, which is amorphous.

13. The powder as claimed in claim 1, which is crystalline.

14. The powder as claimed claim 1, wherein said at least one polyaryletherketone is a polyetherketoneketone.

15. A process for manufacturing a powder as claimed in claim 1, comprising:
a step of supplying, in the melt state, the composition comprising said at least one flexible thermoplastic polymer dispersed in the polymer matrix comprising said at least one polyaryletherketone;
a step of spraying said composition in the melt state, to form droplets of molten composition;
a step of cooling the droplets of molten composition to form solid particles; and,
optionally one or more heat treatment steps.

16. A method of using the powder as claimed in claim 1, in a process for the layer-by-layer construction of objects by electromagnetic radiation-mediated sintering, in a powder coating, powder compression molding or powder compression-transfer molding process.

17. An object obtained by one of the processes as claimed in claim 16,
said object having an elastic modulus of strictly less than 4 GPa, as measured on a 1BA test specimen at 23° C. according to the ISO 527-1:2019 standard.

18. An object obtained by one of the processes as claimed in claim 16, preferentially obtained by a process for the layer by layer construction of objects by electromagnetic radiation mediated sintering, said object having a Charpy impact strength of greater than or equal to 5 kJ/m², for a type A notched bar according to the ISO 179:2010 standard.
